(19) United States
(12) Patent Application Publication
(10) Pub. No.: US 2009/0144143 A1
(43) Pub. Date: Jun. 4, 2009

(54) System, Method, And Apparatus For Data-Driven Interactive Wayfinding And Associated Services

(76) Inventor: G. V. IYER, Alpharetta, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 11/952,096

(22) Filed: Dec. 6, 2007

Related U.S. Application Data
(60) Provisional application No. 60/868,932, filed on Dec. 6, 2006.

(51) Int. Cl. G01C 21/00; G06F 17/30; G06Q 30/00

(52) U.S. Cl. 705/14; 707/3; 701/206; 707/E17.108

(57) ABSTRACT

A system, method, and apparatus for providing interactive digital wayfinding to users includes a visual representation of a floor layout on an interactive display, providing services to attendees in rich multimedia output format, including locating exhibitor information based on search criteria, and plotting a path from the user to an exhibitor's booth; viewing exhibitor-specific information, such as a description or video spot based on context of search; viewing new products or services for different categories of exhibitors; requesting information on an exhibitor and/or their product/service to be sent by email or to a PDA via input of attendee badge, smart card, or other information; viewing information on sessions, conference schedules, meetings and workshops; scheduling a meeting with an exhibitor during the tradeshow; answering survey questionnaires; obtaining information on exhibitor promotions; enrolling for exhibitor giveaways; finding local things to do; finding local places of interest; and other related information.

### CROSS-REFERENCE AND PRIORITY CLAIM TO RELATED APPLICATION

To the fullest extent permitted by law, the inventor of the present non-provisional patent application claims priority to, and the full benefit of, U.S. Provisional patent application entitled, “SYSTEM, METHOD, AND APPARATUS FOR DATA-DRIVEN INTERACTIVE WAYFINDING AND ASSOCIATED SERVICES” filed on Dec. 6, 2006, having assigned Ser. No. 60/868,932; United States Non-Provisional patent application entitled, “SYSTEM, METHOD, AND APPARATUS FOR DATA-DRIVEN INTERACTIVE WAYFINDING AND ASSOCIATED SERVICES”, filed on Dec. 6, 2007, having assigned Ser. No. 11/952,096, on behalf of the inventor, G. V. Iyer.

### TECHNICAL FIELD

The present invention relates generally to a system, method, and apparatus for providing interactive services to users, and, more particularly, to providing a system, method, and apparatus directed to interactive digital wayfinding, and related services, to exhibition/tradeshow attendees, exhibitors, and organizers, and to users in malls, sports venues and stadiums, museums and exhibit halls, convention and conference centers, store-front and retail locations, university and corporate campuses, hotels and resorts, entertainment complexes, parking lots, and the like.

### DESCRIPTION OF RELATED ART

In large tradeshows, such as those with more than 500 exhibitors, attendees face the challenges of effectively utilizing the available time and in gathering the right information they desire from the right exhibitors. Printed maps and cross references with booth and company information are cumbersome to use and cannot effectively deliver the right information in an intuitive manner immediately to the attendees. Attendees also want the convenience of requesting information through an electronic means from various exhibitors because of lack of time, and for their personal convenience in reducing the chore of carrying brochures and handouts.

Kiosks are useful for informational purposes, but do not deliver one-on-one visual presentation appeal and the intuitive navigation through rich multimedia that users prefer.

Similar challenges exist in the fields of mall services, sports venues and stadiums, museums and exhibit halls, convention and conference centers, store-front and retail locations, university and corporate campuses, hotels and resorts, entertainment complexes, parking lots, and the like, wherein a content-rich, user-centric, interactive digital wayfinding system, method, and apparatus would preferably include a visual representation of the entire tradeshow or other field-specific floor plan on large touch screen display or overlay or interactive projection system, providing services to show/conference attendees and other users, including locating exhibitor, vendor, or store front information based on search criteria like name, booth or store number, category/sub-category, or product/item, and plotting a wayfinding path to locate and travel to said location, such as an exhibitor's booth; viewing exhibitor, vendor, or store front specific information such, as detailed description or video content or promotion based upon context of search; viewing new products or services for different categories/sub-categories of exhibitors, vendors, or store fronts; requesting information on a specific exhibitor, vendor, or store front and/or their products and/or services to be sent by email or to a PDA by such means as scanning, identification, or other input of attendee or user via badge, smart card, or other input of information or the like; viewing information on sessions, conference schedules, meetings and workshops; requesting and/or scheduling meetings with exhibitors, vendors, or store fronts during tradeshows or the like; answering survey questionnaires; obtaining more information on exhibitor, vendor, or store front promotions; enrolling for exhibitor, vendor, or store front giveaways; finding things to do in town; finding places of interest in town; and other related information.

Therefore, it would be beneficial to have a system, method, and apparatus for providing interactive digital wayfinding, and such above-described related services, to users.

### BRIEF SUMMARY OF THE INVENTION

Briefly described, in a preferred embodiment, the present invention overcomes the above-mentioned disadvantages and meets the recognized need not met by the prior art by providing a system, method, and apparatus for providing interactive digital wayfinding, and related services, to exhibition/tradeshow attendees, exhibitors, and organizers, and to users and stores in malls, sports venues and stadiums, museums and exhibit halls, convention and conference centers, store-front and retail locations, university and corporate campuses, hotels and resorts, entertainment complexes, parking lots, and the like.

In general, a system according to a preferred embodiment of the present invention includes a CPU which runs all the software components and visual rich multimedia content, a large format touch screen, or overlay or interactive projection system, (preferably 19 inches or larger) connected to the CPU, peripheral devices such as printers, badge readers and speakers, and optional internet connectivity based on mode of operation, for example, but not limitation, standalone (no connection), LAN (connected through an Edge Server at the Event Location), or Internet (direct connection to the internet to access a Central Server).

The capabilities of a system according to a preferred embodiment of the present invention include, but are not limited to: a visual representation of entire show floor on a large touch screen; intuitive searching by name, booth, and category for all exhibitors; means to ascertain a best route to get to a desired location, such as an exhibitor booth, from a current location; visual indicia, such as booths, providing touch-functionality on the screen to get more information on an exhibitor for the specific booth; capability to integrate with attendee badges or card readers, and support requests for information on exhibitors; viewing a “What's New” section for each category, providing for exhibitors to showcase their products or services through rich multimedia and video content or spots on the screen to the attendees; and, providing session details, workshops, event schedules that can all be made available at the touch of a button on the tradeshow floor or near the entrances.

The modes of operation of a system according to a preferred embodiment of the present invention include, but are not limited to: stand-alone with no connections to other interactive digital wayfinder CPUs and no internet connection, wherein all data is local to the CPU for this mode; LAN connectivity (connected by Local Area Network by wired or wireless means) to other systems at the Event Location) with a local Edge Server (which manages content and functions of all the interactive digital wayfinding CPUs, and wherein internet connection is available for the local Edge Server), whereby all data is periodically refreshed from the Local Edge Server to the individual CPUs, and whereby requests for information and other email traffic will be handled by the local Edge Server; and/or internet enabled (direct connection to the internet to access a remote Central Server), whereby all data is periodically refreshed from the remote central server to the individual CPUs, and whereby requests for information and other email traffic are handled by the remote central server.

The present invention may be implemented using hardware, software, firmware, and/or any combination thereof, and may take the form of a method, an apparatus, a system, a computer readable program, or the like.

Accordingly, a feature and advantage of the present invention is its ability to provide an apparatus, system, method and computer program for digital wayfinding and related services.

Another feature and advantage of the present invention is its ability to provide an apparatus, system, method and computer program for providing a visual representation of the entire tradeshow or other field-specific floor on large touch screen display, or overlay or interactive projection system.

Still another feature and advantage of the present invention is its ability to provide an apparatus, system, method and computer program providing for providing services to show/conference attendees and other users, including locating exhibitor, vendor, or store front information based on search criteria like name, booth or store number or category/sub-category, and plotting a wayfinding path to locate and travel to said location, such as an exhibitor's booth.

Yet another feature and advantage of the present invention is its ability to provide an apparatus, system, method and computer program for viewing exhibitor, vendor, or store front specific information such, as detailed description or video content or promotions based upon context of search.

Yet still another feature and advantage of the present invention is its ability to provide an apparatus, system, method and computer program for viewing new products or services for different categories/sub-categories of exhibitors, vendors, or retail store fronts, with the help of a virtual assistant, to view the details of the product or service, and to plot or highlight a wayfinding path to locate and travel to said location, such as a rack or section in the store having said product.

Yet still another and further feature and advantage of the present invention is its ability to provide an apparatus, system, method and computer program for requesting information on a specific exhibitor, vendor, or store front and/or their products or services to be sent by email or to a PDA by scanning, identification, or other input of attendee or user badge, smart card, other information, loyalty program card, or the like.

Still another feature and advantage of the present invention is its ability to provide an apparatus, system, method and computer program for viewing information on and regarding sessions, conference schedules, meetings and workshops; for requesting/scheduling meetings with exhibitors, vendors, manufacturers, brands, or store fronts during tradeshows, or the like.

Still another feature and advantage of the present invention is its ability to provide an apparatus, system, method and computer program for answering survey questionnaires.

Still another feature and advantage of the present invention is its ability to provide an apparatus, system, method and computer program for obtaining additional information on exhibitor, vendor, or store front promotions.

Still another feature and advantage of the present invention is its ability to provide an apparatus, system, method, and computer program for enrolling for exhibitor, vendor, or store front giveaways.

Still another feature and advantage of the present invention is its ability to provide an apparatus, system, method, and computer program for an interactive digital wayfinding system and associated services such as the customer engagement process, virtual assistant interaction, product category, subcategory, family or item search engine, and corresponding wayfinding locator in the store for a multi-level store-front retail operation.

Still another feature and advantage of the present invention is its ability to provide an apparatus, system, method and computer program for finding things to do in town; for finding places of interest in town and other related information.

These and other objects, features, and advantages of the invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present invention will be understood best through consideration of, and reference to, the following Figures, viewed in conjunction with the Detailed Description of the Preferred Embodiment referring thereto, in which like reference numbers throughout the various Figures designate like structure and in which:

FIG. 1 is a block diagram illustrating a system configured to implement a preferred embodiment of the present invention;

FIG. 2 is a block diagram illustrating a Technical Software Architecture Overview of the system configured to implement a preferred embodiment of the present invention, further detailing the base Operating Systems Layer of software, the software Control Layer of software which provides the infrastructure for the interactive Digital Wayfinding Application, and the Digital Wayfinding Application Layer along with support applications and data of the present invention;

FIG. 3 is a block diagram illustrating a system configured to implement a preferred embodiment of the present invention, further showing the Software Control Layer modules and the underlying data of the present invention;

FIG. 4 is a block diagram illustrating a system configured to implement a preferred embodiment of the present invention, further showing the modules for the interactive digital Wayfinding Programs of the present invention;

FIG. 5 is a screenshot detailing the main screen layout of a tradeshow application with sample context-driven marketing opportunities for exhibitors and sponsors in the tradeshow, and illustrating a preferred embodiment of the present invention;

FIG. 6 is a series of snapshots illustrating a system configured to implement a preferred embodiment of the present invention, further showing the various functionalities of the interactive digital wayfinding system of the present invention for a tradeshow application;

FIG. 7 is a series of snapshots illustrating a system configured to implement a preferred embodiment of the present invention, further showing various functionalities of the interactive digital wayfinding system of the present invention and associated services such as the customer engagement process, virtual assistant interaction, product category, subcategory, family or item search engine, and corresponding wayfinding locator in the store for a store-front retail application;

FIG. 8 is a screen snapshot illustrating a system configured to implement a preferred embodiment of the present invention, further showing various functionalities of the interactive digital wayfinding system of the present invention for a mall application;

FIG. 9 is a sample advertising options screenshot for a mall application illustrating an alternate embodiment of the present invention;

FIG. 10 illustrates an implementation of a Content Management System which provides clients with operations required to maintain the interactive digital wayfinding system of the present invention;

FIG. 11 illustrates an implementation of the interactive digital wayfinding system of the present invention for special events su ch as association conference and meetings in a convention center or conference and meeting facility, further depicting the layout of the facility with one or more levels, within a 3D model, and further demonstrating schedules and events which are tagged in the respective halls, rooms, and other locations in the facility, and still further illustrating an attract loop cycling through the conference agenda and an interactive mode to respond to a touch on a specific item on the display of the present invention; and,

FIG. 12 illustrates a system configured to implement a preferred embodiment of the present invention, further showing various functionalities of the interactive digital wayfinding system of the present invention and associated services such as the customer engagement process, virtual assistant interaction, product category, subcategory, family or item search engine and corresponding wayfinding locator in a store for a multi-level store-front retail operation application.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE PREFERRED AND SELECTED ALTERNATIVE EMBODIMENTS

To the fullest extent permitted by law, the inventor of the present non-provisional patent application claims priority to, and the full benefit of, U.S. Provisional patent application entitled, “SYSTEM, METHOD, AND APPARATUS FOR DATA-DRIVEN INTERACTIVE WAYFINDING AND ASSOCIATED SERVICES” filed on Dec. 6, 2006, having assigned Ser. No. 60/868,932; United States Non-Provisional patent application entitled, “SYSTEM, METHOD, AND APPARATUS FOR DATA-DRIVEN INTERACTIVE WAYFINDING AND ASSOCIATED SERVICES”, filed on Dec. 6, 2007, having assigned Ser. No. 11/952,096, on behalfof the inventor, G. V. Iyer.

In describing preferred embodiments of the present invention illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose.

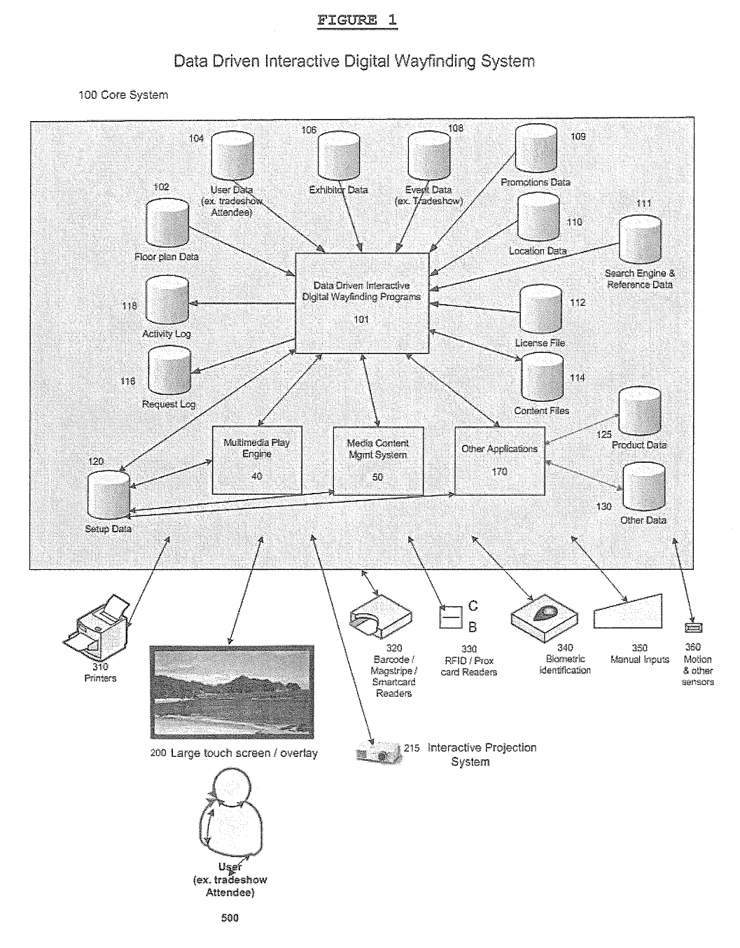

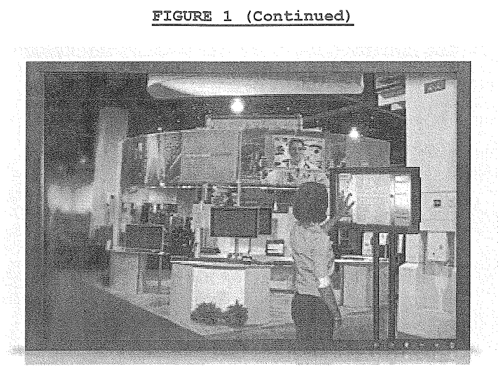

In that form of the preferred embodiment of the present invention chosen for purposes of illustration, FIG. 1 illustrates a block diagram of the interactive digital wayfinding system of the present invention as implemented for a tradeshow, exposition or conference, including methods and/or computer program products according to various related embodiments of the present invention. As shown in FIG. 1, the interactive digital wayfinding systems, methods, and/or computer program products 100 interface with various optional peripheral devices, such as large touch screen/overlay 200 or an interactive projection system 215 for input and output display, printers 310 (all types including different sizes and technologies) for output, barcode or smartcard or magnetic stripe card readers 320 for reading different type of badges and other information barcode or smartcard inputs, RF identification or proximity card identification readers 330 for reading different type of badges and other information inputs, biometric identification devices 340, other types of input including manual inputs 350, such as a physical keyboard/mouse, onscreen keyboard, or other input options, or other types of sensors 360 such as motion sensors, to trigger various events.

The user, such as a tradeshow attendee 500, interfaces with large touch screen/overlay 200, interactive projection system 215, and other optional peripheral devices 310, 320, 330, 340, 350 or 360 for various functionality provided by interactive digital wayfinding system 100.

In FIG. 1, core interactive digital wayfinding system 100 comprises interactive digital wayfinding programs 101 which read all the input data required by the system, exemplar data including floor plan data 102, which may comprise information on floor plans and floor levels as may be obtained from CAD drawings, booth sizes, booth numbers, aisle sizes, concession stands, number of booths, meeting rooms, rest rooms and related information, user data such as attendee data 104, which may comprise information on attendees to the tradeshow including contact information, exhibitor data such as tradeshow exhibitor data 106, which may comprise information such as company name, contact personnel information, description and listing of products and services offered, tradeshow events, booth number, and the like, event data such as tradeshow data 108, which may comprise name, date of event, venue details, event schedule, conference schedule, exhibitor information including name, booth number, size of booth, sponsorship level, sponsors, total number of participants, and related information, promotions data 109, which may comprise promotion reference codes, effective dates, applicability, product, service, category, location criteria, price reduction, related promotions, restrictions, reference images and media, originating department, origination person and contact information, location data such as a convention center 110, which may comprise name, information on facilities, places of interests, advertisers, attractions, and the like, search engine and reference data 111, which may comprise any and all other supporting data or databases required by search engines and all other modules in FIG. 1, license file 112 which may comprise data for validation of license to use, expiry criteria, product keys, and the like, content files 114, which may comprise any and all media, text, and other files which are used to display or process for display, setup data 120, which may comprise any and all files, databases, and other information to identify and/or configure specific location and type of set up.

In FIG. 1, core interactive digital wayfinding system 100 comprises interactive digital wayfinding programs 101 which output data including activity log 118, which may comprise data including log of all activity, alerts, sending of information to other systems, including remote servers through LAN, WAN or internet, and request log 116, which may comprise data including log of all requests for information, meeting requests, sending of information to other systems for processing including remote servers through LAN, WAN or internet, sending of information to email recipients and/or personal digital assistant devices (“PDAs”), including show information to users/attendees, exhibitor information to users/attendees, leads to exhibitors, meeting requests to users and/or exhibitors, and related services.

In FIG. 1, core interactive digital wayfinding system 100 comprises interactive digital wayfinding programs 101, which interface with other systems including multimedia play engine 150, which may provide forrich multimedia display with playlist and schedule functionality on touch screen display/overlay 200, media content management system 160, to manage and maintain all content and, optionally, network one or more interactive digital wayfinding systems, other third party applications 170, such as mapping programs, product catalog and selector programs, or other controls.

Wayfinding Connection Logic:

Based upon the representative inputs as shown in FIG. 1, and rules that may be defined in the set-up data or customized for a specific implementation, the interactive digital wayfinding programs display the virtual floor plan, along with each of the functional options for the user to interact with the system of the present invention. The choice of a target location is obtained based upon a user's interaction with the system of the present invention, and the programs calculate the optimal path from a reference point location, usually a current location of the wayfinder, to the final destination booth, and preferably animates a visual path on the touch screen to show the user an optimal way to get to the target booth location. Based upon the size of the floor plan displayed, the programs may scroll and pan the floor plan left or right, up or down, to show the relevant portion of the floor plan. A scroll bar indicator at the top of the screen preferably indicates the current view portion of the floor plan displayed on the screen. Optionally, when the tradeshow spans multiple levels or venues, thumbnails of various other levels or locations may be shown and the user may switch context to such other levels or locations to view their floor plans and booths, along with the wayfinding and search engine capabilities.

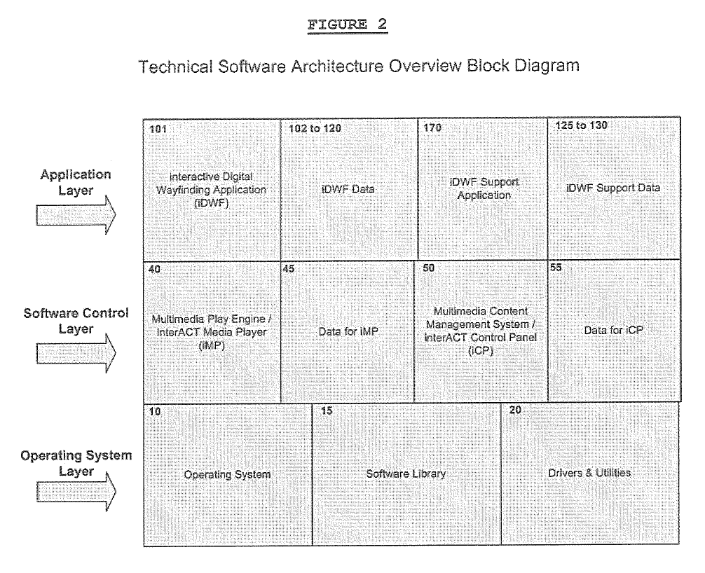

FIG. 2 is a block diagram illustrating a Technical Software Architecture Overview of the system configured to implement a preferred embodiment of the present invention. FIG. 2 shows the base Operating Systems Layer of software, the software Control Layer of software which provides the infrastructure for the interactive Digital Wayfinding Application, and, finally, the Digital Wayfinding Application Layer, along with support applications and data.

In FIG. 2, the Operating System Software Layer preferably comprises operating system 10, which is responsible for the media player to boot and have the base functionality of a computer CPU, software libraries 15 which are additional software components required by the operating system (for example, Microsoft .NET framework), and other drivers and utilities 20 for the CPU to communicate with associated peripherals and display devices.

In FIG. 2, the Software Control Layer may comprise a multimedia play engine, such as the interACT Media Player (iMP) 40, which is responsible for displaying validated multimedia content properly on a display device, and which further controls the behavior of the display based on the features of iMP 40, along with data for the iMP 45, such as playlists and schedules. The multimedia Content Management System, such as the interACT Control Panel (iCP) 50, are additional software components required along with the database and data for iCP 55 to provide functionality for:

(a) a web-based user interface to manage the set up of the media players and display screens (Stage), media elements and data driven templates(Spots), multimedia playlists (Shows) and schedules;

(b) user maintenance and security modules;

(c) modification and publishing of content;

(d) distribution based on attributes of the Stage; and

(e) play and status reports, and alert notifications.

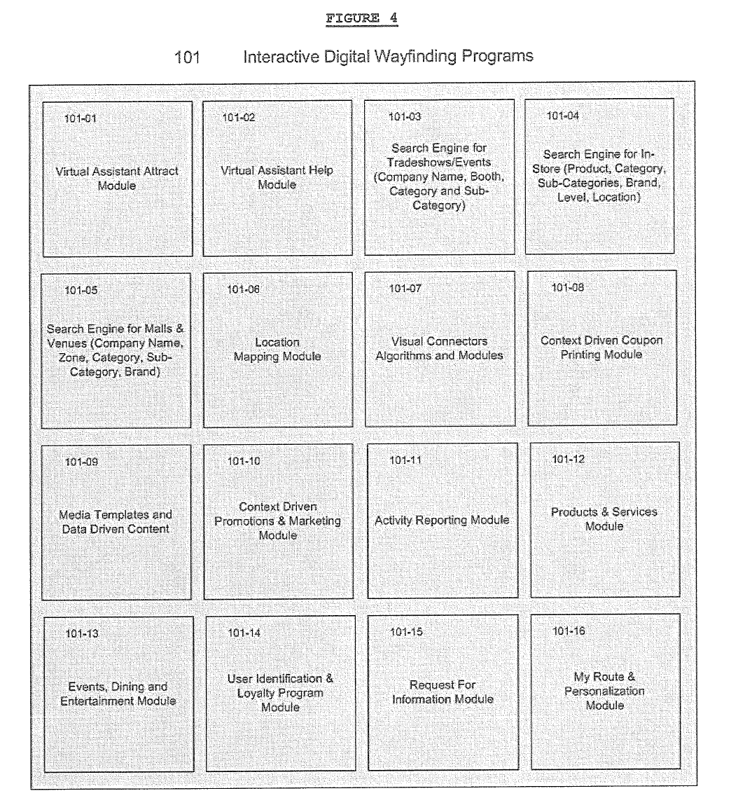

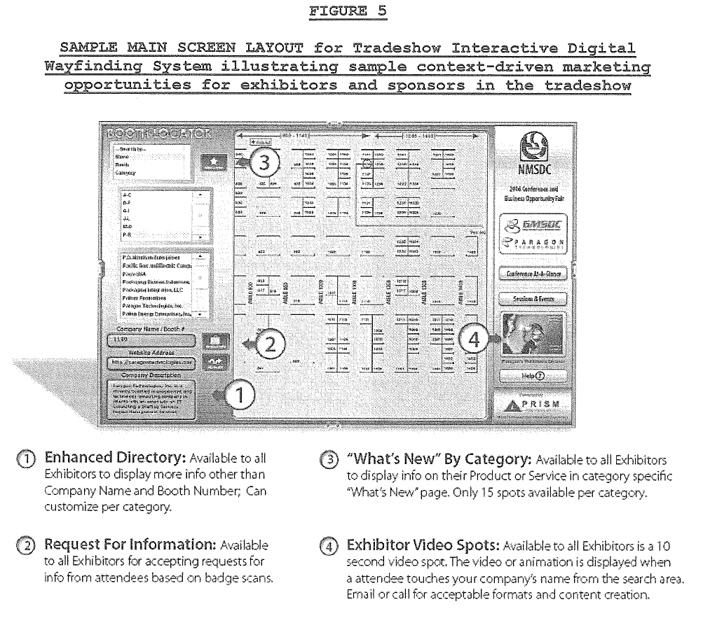

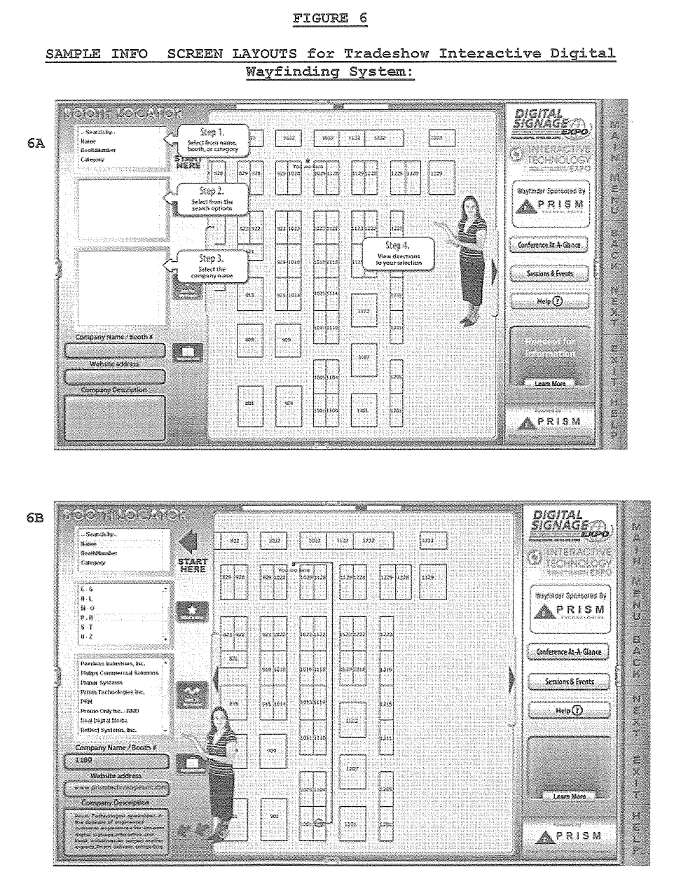

In FIG. 2, the Application Layer preferably comprises interactive Digital Wayfinding Application (iDWF) 40, along with any required iDWF data 102 through 120 (see FIG. 1), which is responsible for such functionality specific to the Digital Wayfinding Application, as shown in FIGS. 1 and 4. Additional iDWF Support Applications 170, along with iDWF Support Data 125 through 130 (see FIG. 1) are software components to provide additional functionality for iDWF 101, such as Product Master and Bill of Materials information, and product related promotions.

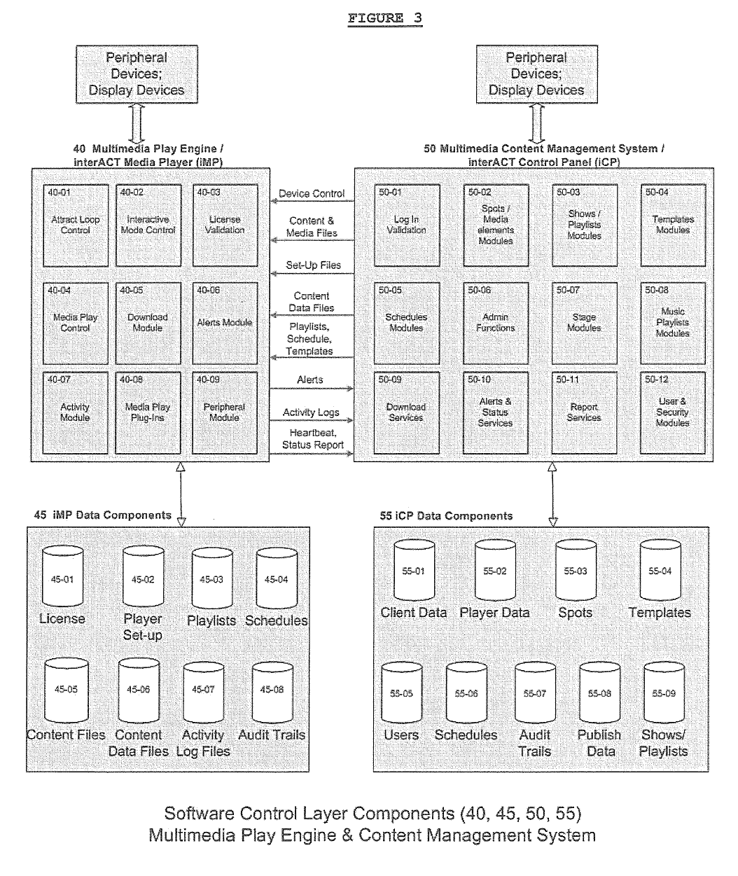

FIG. 3 is a block diagram illustrating a system of the present invention configured to implement a preferred embodiment of the present invention. It shows the Software Control Layer Components comprising a multimedia play engine (interACT Media Player, iMP) 40, its related data components, iMP Data Components 45, multimedia Content Management System (interACT Control Panel, iCP) 50, and its related data components, iCP data components 55.

In FIG. 3, interACT Media Player (iMP) 40 may comprise the following modules:

(a) Attract loop 40-01 is responsible for looking at schedules 45-04 for a reference point in time and for playing content files 45-05 as listed in playlists 45-03. All content files 45-05 with dynamic data and all template content files 45-05 receive or obtain dynamic data from content data files or database files 45-06. Preferably, all activity is logged within activity log files 45-07;

(b) Interactive mode control 40-02 is responsible for controlling the behavior of the play engine when it is set to an “interactive” mode as per player set-up data 45-02, and is invoked when a user touches the touch screen/overlay or is triggered by keyboard or mouse activity or an event from a sensor such as a motion sensor or pressure mats (i.e., peripheral devices). Playlists 45-03 contain information regarding interactive content to be played or interactive action that is to be taken;

(c) License validation module 40-03 reads license information 45-01 to make a determination of the validity, in order to invoke media play engine functionality;

(d) Media play control 40-04 is responsible for ensuring that the right content plays at the right time with the right quality. All activity is preferably logged in activity log files 45-07, and audit trails 45-08 are also preferably maintained;

(e) Download module 40-05 ensures that iMP 40 has all required content, data, and set-up files to play as per the specifications in iCP 50 system and iCP data components 55;

(f) Alerts module 40-06 traps all alert notifications at iMP 40 and notifies the iCP system 50 regarding critical alerts, along with periodic heartbeat and status notifications as per set-up data 45-02;

(g) Activity module 40-07 is invoked by other modules in iMP 40 to maintain a record of the activities, and to write to the activity log files 45-07 and the audit trails 45-08, as required;

(h) Media play plug-in modules 40-08 are invoked by other modules in iMP 40 for playing various formats of data within associated content files; and,

(i) Peripherals module 40-09 provides required interfaces for peripheral devices such as card readers, RFID readers, proximity cards, motion sensors, biometric devices, touch drivers, camera devices, and the like.

In FIG. 3, interACT Control Panel (iCP) 50 preferably comprises the following modules:

(a) Log in validation 50-01 is responsible for allowing only authorized users of the system access to specific areas of the system and data as per their profile and security settings in User 55-05 and client data 55-01 files;

(b) Media elements are organized as Spots in iCP system 50 and Spots are used to specify static, dynamic, and data driven template content 55-03 in the system. Spots modules 50-02 let users create, modify, or delete Spots;

(c) Shows modules 50-03 let users of iCP system 50 create, modify, or delete playlists, also known as Shows (collection of Spots) 55-09;

(d) Templates modules 50-04 provide functionality to create Spots from existing templates 55-04 and Spots Data files 55-03;

(e) Schedules modules 50-05 help define the schedules 55-06 for Shows for a specific media player iMP 40 or a group of media players iMP 40;

(f) Admin Functions 50-06 include links to various other modules, and are used to define the set up of iCP system 50 for a specific client as per client data 55-01 and user data 55-05;

(g) Stage modules 50-07 define set-up details of various iMPs 40 for a given client as per player data modules 55-02. This, preferably, may also include the display screen set up, device control, and reporting preferences for the user;

(h) Music playlists modules 50-08 let users create, modify, and delete music playlists 55-09 as supported by the music channel play feature of iMP 40;

(i) Download services 50-09 support the transfer of changed or new content, data, and set-up files for specific iMP systems 40 in a network of such players and as defined by publish data 55-08;

(j) Alerts and Status services modules 50-10 receive alerts, heartbeat, and status reporting of the iMP systems in a given client network, and prepare notifications and reporting as required in client data 55-01. Audit trail records 55-07 preferably are logged as events are triggered;

(k) Report services modules 50-11 handles the reporting needs of iCP system 50 using data from data sources 50-01 through 50-09; and,

(l) User and security modules 50-12 provide the user interface to create, modify, and delete user profiles, and security access levels, as well as preferences.

FIG. 4 is a block diagram illustrating a system configured to implement a preferred embodiment of the present invention. It shows the modules for the interactive digital Wayfinding Programs of the present invention.

In FIG. 4, the Interactive Digital Wayfinding Programs 101 preferably comprise the following program modules:

(a) Virtual Assistant Attract Module 101-01 functions as an attract loop, while system 101 (see FIG. 1) is in idle state, that is, not being used by user 500, and may be in a timed loop, activated by motion, pressure mat, or other sensors 360 (see FIG. 1) to awaken and play content which invites interaction with the system or more information on the system. Exemplar data could include an animated video, graphic or 3D character of a person, form or object which greets passers-by and talks about the use of the system;

(b) Virtual Assistant Help Module 101-02 is activated when a user first interacts with the interactive digital wayfinding system 100 to help them navigate and use the system. It may also be activated when the user presses a “HELP” button on the screen at any time;

(c) Search Engine for Tradeshows/Events 101-03 provides functionality to search exhibitor information by various criteria, such as company name, booth number, or category and/or sub-category;

(d) Search Engine for In-store store fronts and retail locations 101-04 provides functionality to search product items by various criteria, such as product category and sub-categories, level/location/zone, brand, or product family and/or sub-families;

(e) Search Engine for Malls or Venues 101-05 provides functionality to search store/item-of-interest information by various criteria, such as name, level/zone/location or category and/or sub-categories;

(f) Location mapping modules 101-06 take location data 110, exhibitor data 106, floor plan data 102, and event data 108, and maps points of interest for the user interface and internal workings of wayfinding system 101;

(g) Visual Connectors algorithms and modules 101-07 use location data 110 in FIG. 1, exhibitor data 106, floor plan data 102, event data 108, and set-up data 120 to draw a visual path on the virtual walkway aisles from the relative or physical position of the wayfinder on the tradeshow floor to the desired location, such as a specific booth for a company. Alternatively, the relative origin and destination positions may be visually highlighted;

(h) Context Driven Coupon Printing Module 101-08 is triggered during user interaction with the wayfinding system 100. Product data 125, location data 110, exhibitor data 106, Search Engine Data 111, and other such data 130 could trigger related promotions data 109 to display context sensitive promotions and messaging data, such as a coupon offer for printing 310 by a user;

(i) Media Templates modules 101-09 provide functionality to use media elements from existing templates (similar to functionality of Templates Modules 50-04 in FIG. 3). These could be used as dynamic messaging, advertising or special promotions spots, which could occupy the entire display area or just a portion of it;

(j) Context Driven Promotions and Marketing Module 101-10 is triggered during the user interaction with wayfinding system 100. Product data 125, location data 110, exhibitor data 106, Search Engine Data 111, and other such data 130 could trigger related promotions data 109 to display context sensitive promotions and messaging data, such as a display offer for the user;

(k) Activity reporting module 101-11 is invoked by other modules within interactive digital wayfinding programs 101 to maintain a record of activities, to write to activity log files 118 as may be required, and the like;

(l) Products and services module 101-12 is invoked by other applications 170 and modules in wayfinding programs 101 to maintain a copy of the product master for various references and activities including for the search engines, content references such as images and video, visual location mapping (such as zone, section, bay, rack, and/or shelf), inventory position, promotions, pricing, recommendations, brands, and similar products. These modules may also interface with enterprise-wide systems and databases to synchronize or provide snapshot views of product and other reference data in the interactive digital wayfinding system 100;

(m) Events, dining and entertainment modules 101-13 provide reference information and location specific information on events, dining and entertainment opportunities;

(n) User validation and Loyalty Program modules 101-14 provide for a variety of user identification and validation options, such as barcode, magnetic stripe, RFID, biometric, smartcards, or other manual inputs 320 through 350 in FIG. 1. The Loyalty program modules 101-14 preferably may integrate with the provider's system to offer special promotions and personalization;

(o) Request for Information modules 101-15 serve as a gateway to the advertisers, exhibitors, or service providers to request for additional information on products and services and may be automated based on a subscription model. Requests may be forwarded to advertisers, exhibitors, or service providers as a qualified lead, and may also be satisfied in an automated fashion by sending template replies and attachments to the user's email, PDA, cell phone, or the like, or via printing 310 on-site;

(p) My Route and Personalization modules 101-16 serve as time saving and organizing tool for users by letting them add multiple destination locations to be mapped, sorted, and organized for printing 310 on-site or sending to the user's email, PDA, cell phone, or the like. Other personalization tools may also be stored in the system, linked to the user's profile.

Illustrative Functionality by Stakeholder for a Tradeshow User

Attendees:

In large tradeshows, e.g., those with more than 500 exhibitors, attendees face the challenge of effectively utilizing their time and gathering the information they desire from selected exhibitors. Printed maps and cross references with booth and company information are cumbersome to use and cannot effectively deliver the right information in an intuitive manner immediately to the attendees. Attendees also want the convenience of requesting additional information through an electronic means from various exhibitors, because of lack of time and the desire to reduce the chore of carrying brochures and handouts.

Kiosks are useful for informational purpose but do not deliver the one-on-one visual presentation punch and the intuitive navigation through rich multimedia that the interactive digital wayfinding system can achieve.

In an exemplary situation, attendees register for the tradeshow and are given badges (with barcode, smart cards, RF identification tags, or other technology), which identifies the attendee and may carry certain of their identifying or preferred exhibition criteria information. The interactive digital wayfinder system preferably is positioned near the entrances and in high traffic areas on the tradeshow floor, in order to enable the attendees to enhance their productivity and experience by quickly finding the companies they want to visit, and allowing the attendees to visually view on the screen on how to get to the specific booths.

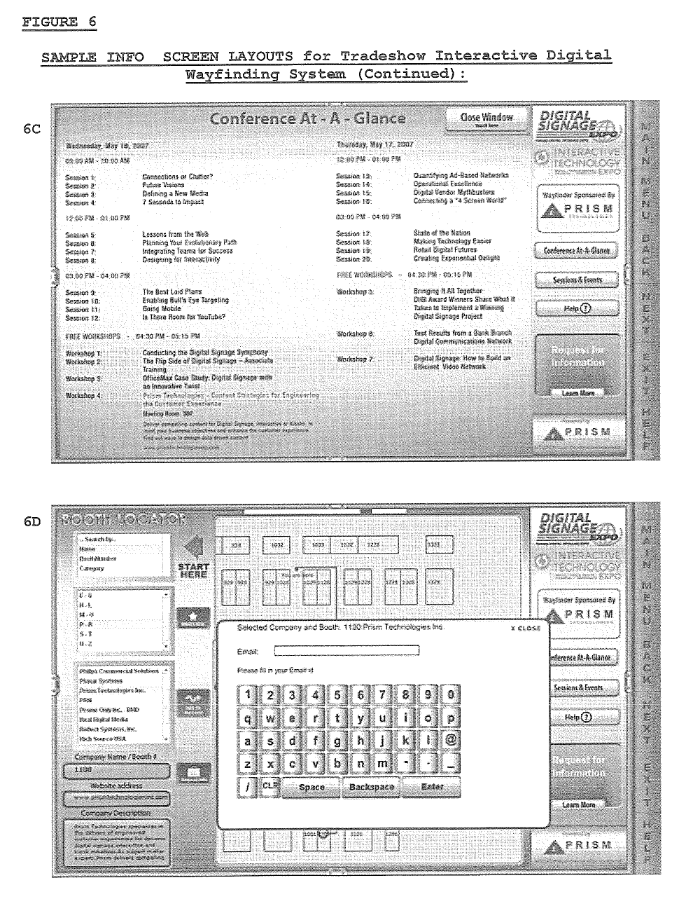

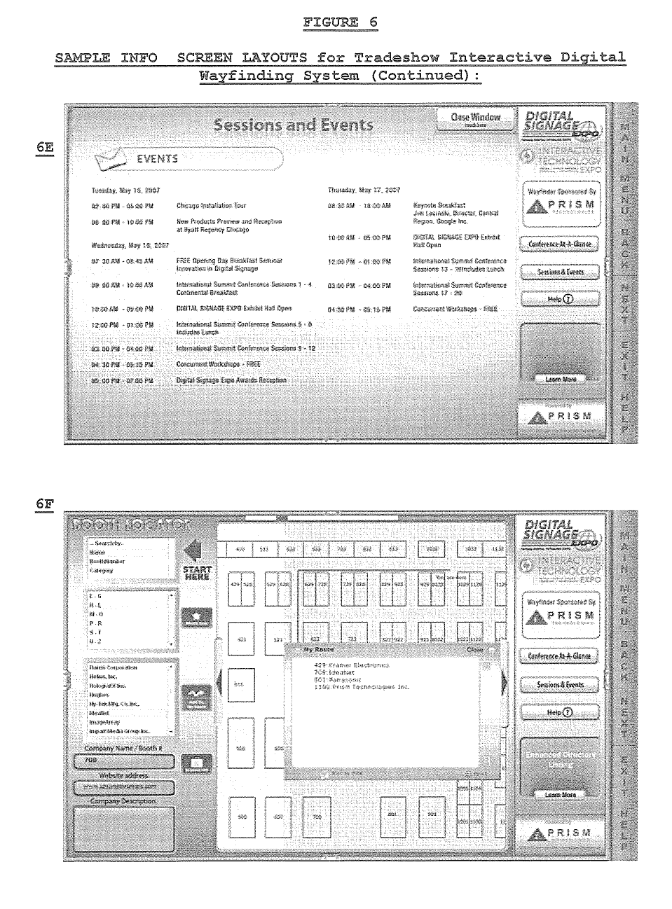

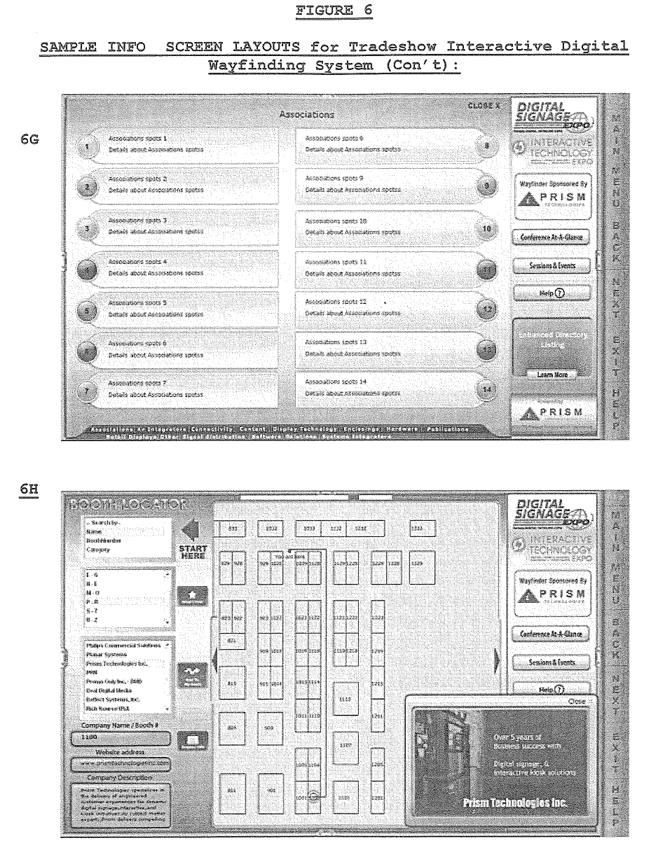

Accordingly, as best seen in FIG. 1, core interactive digital wayfinding system 100 provides the user (such as a tradeshow attendee) interactive functionality such as the following:
(a) Search capabilities on exhibitors (such as exhibiting companies in a tradeshow) by various criteria such as name, booth number or category/sub-category (e.g., such as computer software, lighting, or the like) by touching the selections on the screen and the return system display of results on the touch screen, as shown in FIGS. 6A and 6B;
(b) Digital tracing on the touch screen of route or path from reference point (usually an entrance to a facility or from approximately the current physical location of the equipment) to the selected exhibitor location on the floor plan (such as exhibitor booth location), as shown in FIG. 6B;
(c) Displaying enhanced directory information on exhibitors, including company description, products and services offered, video/graphics presentation and listing of new products, services, promotions, or news flash items on the touch screen, as shown in FIG. 6H;
(d) “What's New” pages specific to each search category/sub-category item listing exhibitor information regarding products, services, or news items are displayed on the touch screen, as shown in FIG. 6G;
(e) “Request For Information” on a specific exhibitor or group of selected exhibitors, preferably based upon and provided that this service is subscribed by each exhibitor (such as exhibitor company information or product information), by the attendees' scanning of their badges or inputting their contact information, as shown in FIG. 6D;
(f) “Request For Meeting” with a specific exhibitor or group of selected exhibitors, preferably based upon and provided that provided this service is subscribed by each exhibitor, by the attendees' scanning of their badges or inputting their contact information;
(g) Taking surveys;
(h) Selecting a list of exhibitors to visit and generate a route list of exhibitors, their details (such as tradeshow exhibitors, their booth numbers) and optionally a route map. This information may be printed or sent electronically to the user's PDA, as shown in FIG. 6F;
(i) Obtaining information on conference schedule (best seen with reference to FIG. 6C), workshops, meetings, sessions and events (best seen with reference to FIG. 6E), places to eat, local attractions, things to do in town, and the like;
(j) Obtaining “Show Me How” information via optional visual and audio guide/helper or virtual assistant, which narrates the usage of specific aspects of the system.

Core interactive digital wayfinding system 100 also may preferably provide promotional displays, messages, and information, using rich multimedia when the system is not being used by a user (attract loop spots).

Exhibitors:

In large tradeshows, e.g., those with more than 500 booths, exhibitors face the challenge of effectively placing themselves, their products, and services, before their target attendees. There also is no currently available, cost-effective marketing or promotional opportunities using rich multimedia to target their ideal customers and to enable the exhibitor to stand-out among industry peers. There is a need, also, to fulfill requests for information from attendees in an automated and expedited fashion.

Accordingly, the interactive digital wayfinder system of the present invention addresses the above-mentioned difficulties and issues for a fraction of the cost of a tradeshow booth. An exhibitor may provide the details for enhanced directory listings and category classifications. For the optional video spots, content and media files may often be provided by the exhibitor.

The system provides extensive search capabilities and categorization of, and/or by, product or service, helping increase traffic of qualified attendees to an exhibitor's booth. The system also supports marketing for the exhibitors by offering enhanced directory listings, multi-second video or graphics presentations (e.g., ten (10) second presentations), listing in the “What's New” category, getting qualified leads with requests for information functionality offered to attendees, and automating replies with relevant information in response to requests for information from attendees.

In addition, through logging capabilities of the system, tradeshow metrics reports will be generated specific to usage for the exhibitor for the show.

Tradeshow Organizers:

Tradeshow organizers seek ways to enhance the experience and productivity of the tradeshow attendees, to help connect the attendees to the right exhibitor, to help boost traffic and qualified leads to exhibitors, and to provide incremental revenue opportunities from untapped services to exhibitors.

Accordingly, the interactive digital wayfinder system addresses the above-described objectives, preferably with no investment from the tradeshow organizers. In addition, with the logging capabilities of the system, tradeshow metrics reports may be generated.

Tradeshow organizers provide detailed information for the tradeshow, exhibitors, floor plans, attendees (through their registration vendor), location, and other set-up data as may be required by the system of the present invention.

Multimedia Content Management Interface—interACT Control Panel (iCP) User Interface

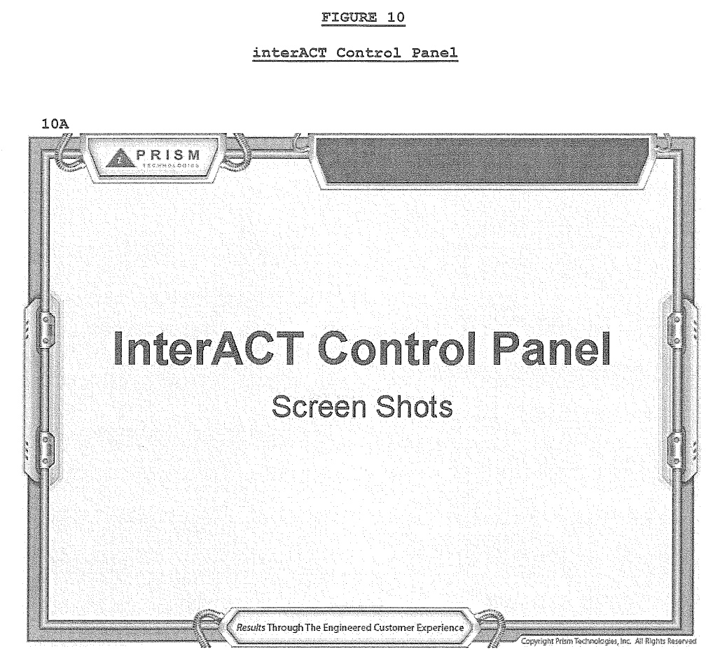

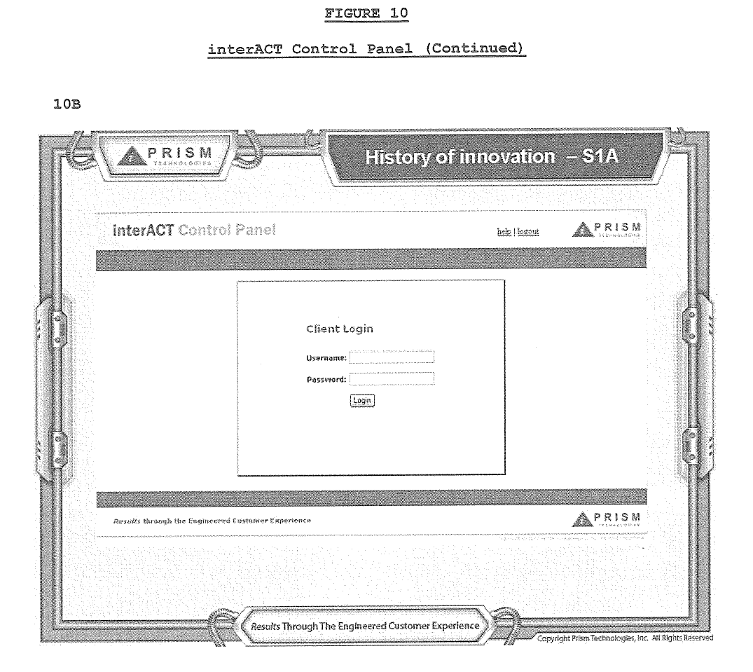

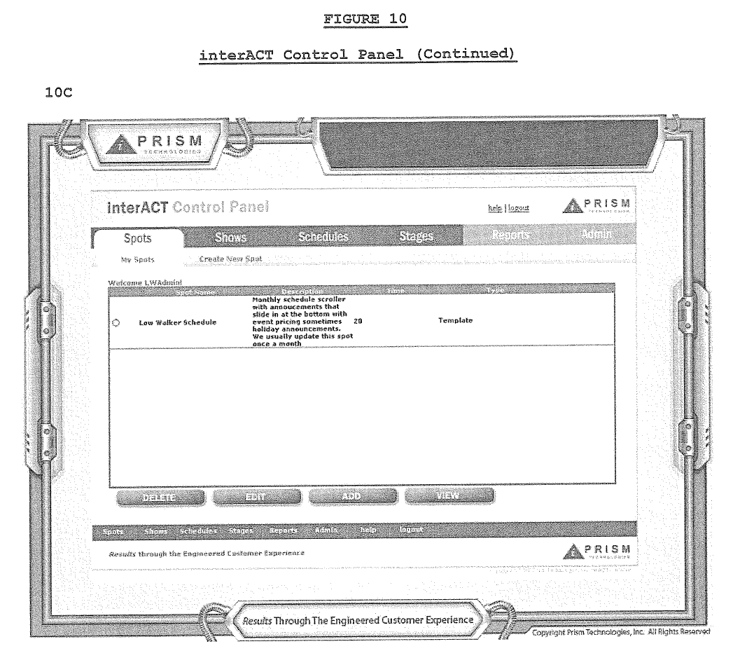

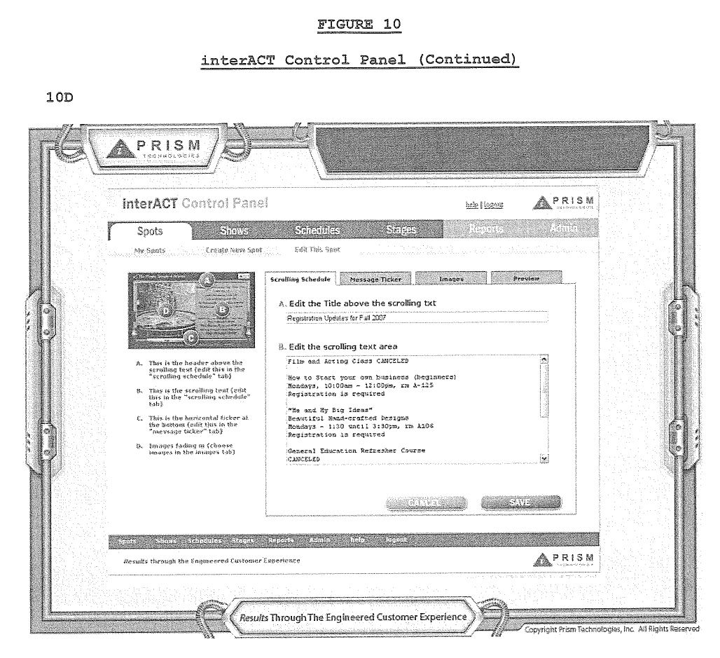

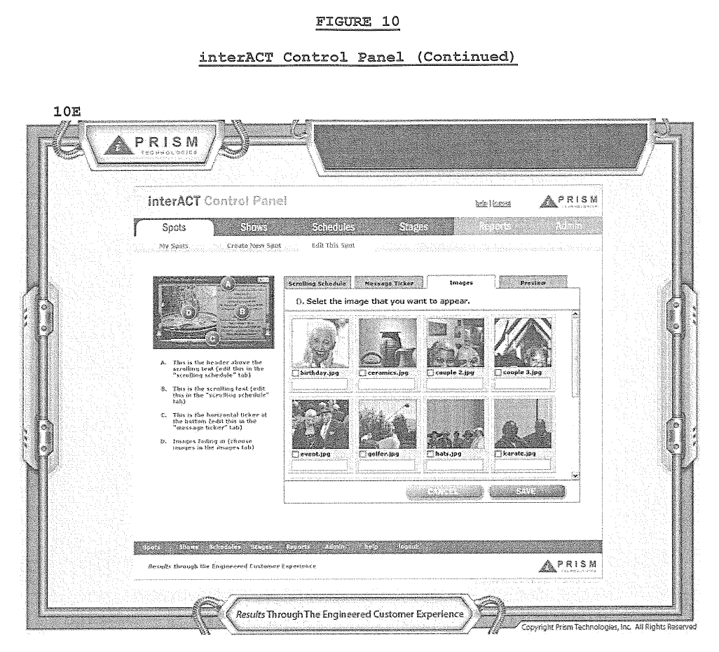

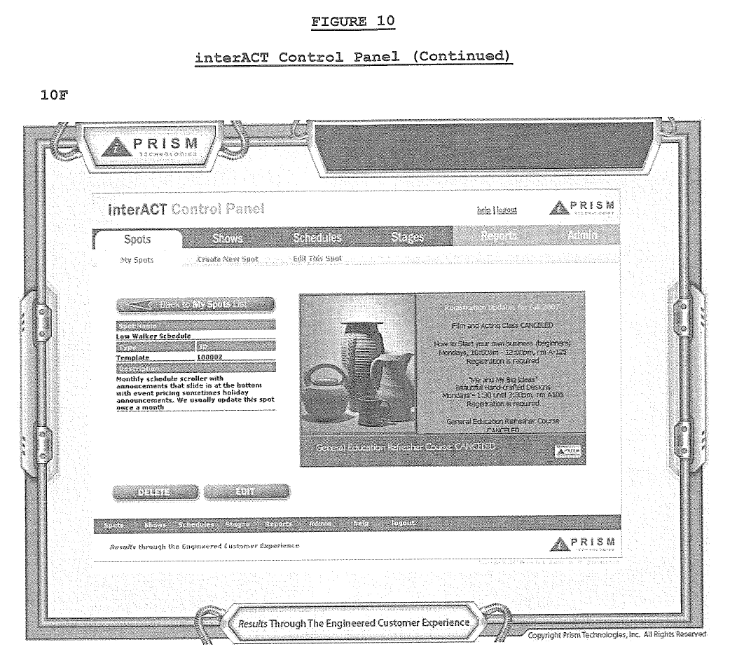

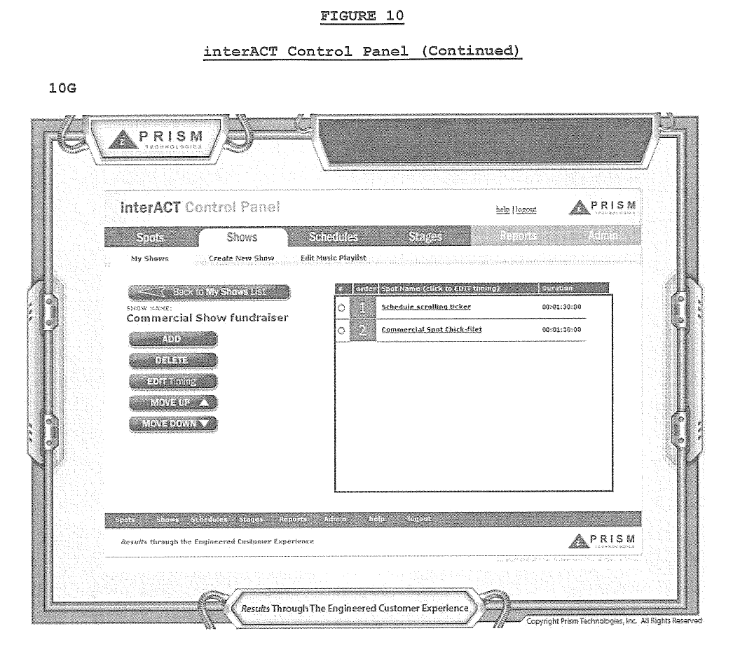

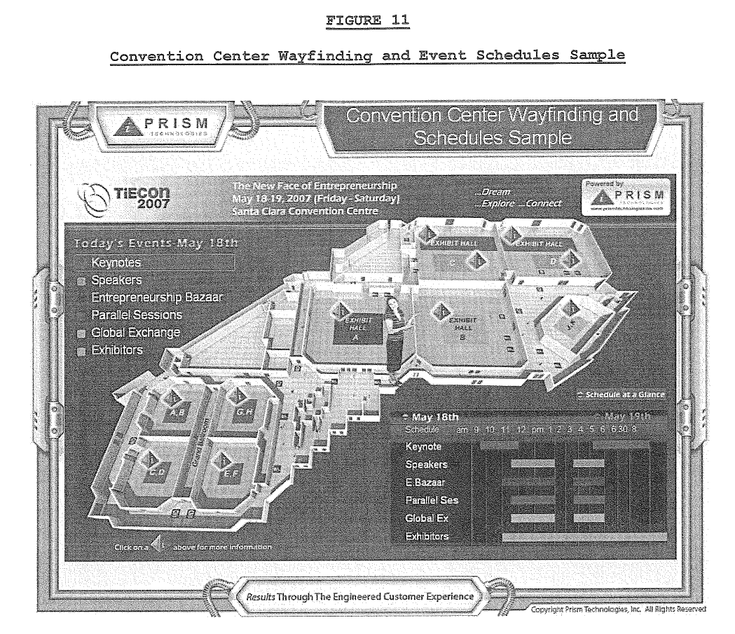

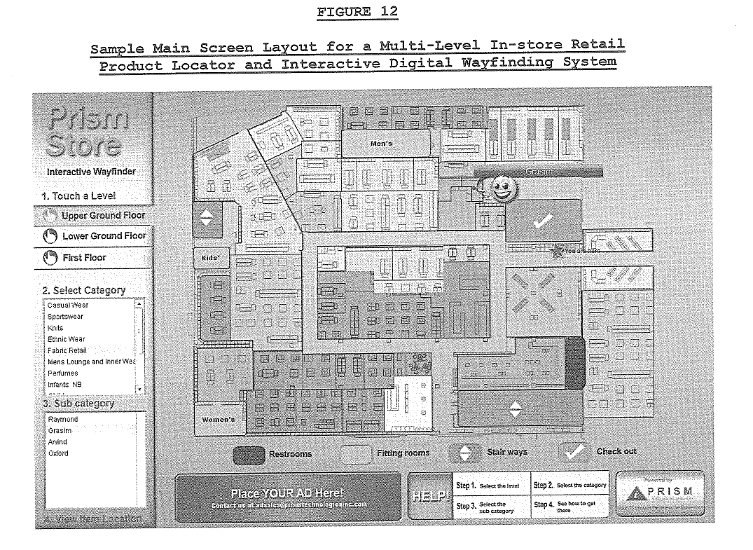

Accordingly, in support of the functionality desired by the aforedescribed stakeholders, FIG. 10 represents an implementation of a multimedia Content Management System, the interACT Control Panel (iCP), which provides stakeholders and/or clients with operations required to maintain the interactive digital wayfinding system of the present invention. Exemplary embodiments of the system of the present invention preferably provide functionality comprising:

(a) a web-based user interface to manage the set up of user media players and display screens (Stage), media elements and data driven templates (Spots), multimedia playlists (Shows), and schedules;

(b) user maintenance and security modules;

(c) modification and publishing of content;

(d) distribution based on attributes of the Stage; and

(e) play and status reports, and alert notifications.

FIG. 10B illustrates a log-in screen which collects data necessary to authenticate and profiles the user;

FIG. 10C illustrates a screen which displays the current Spots for the group of players managed by the user;

FIG. 10D illustrates a screen to maintain the scrolling text for a given data driven Spot template;

FIG. 10E illustrates a screen to maintain the pictures for a given data driven Spot template;

FIG. 10F illustrates a preview of the Spot with the new user data; and

FIG. 10G illustrates a screen which displays the current Shows for the group of players managed by the user.

Adaptation for Other Uses:

Expositions and Conferences with Exhibitors:

This embodiment is similar to that described above with regard to tradeshows.

Shopping Malls—Inside and Outside:

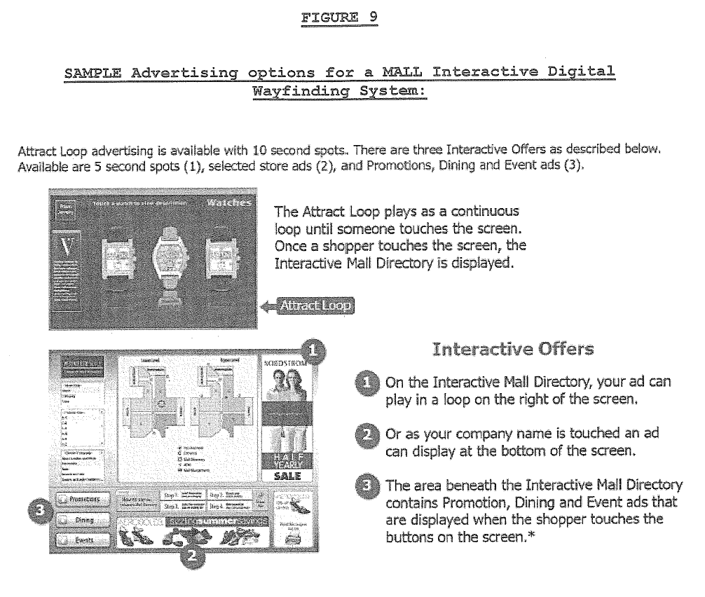

In the implementation of an Interactive Digital Wayfinding System for a shopping mall, the user is the customer in the mall. The floor plan will reflect the floor plan of the mall and may be organized by zones (groups of contiguous stores) as seen in FIG. 8C. The exhibitors are stores in the mall, best seen with reference to FIG. 8A. Based upon the location of the store, the route to the store or zone from the current location will be mapped out by the system and visually represented on the touch screen, best seen with reference to FIG. 8D. In this example, the mall management group plays a role similar to the tradeshow organizer described above. Similarly, advertisers can be stores in the mall or the surrounding area, including outside entities as seen in FIG. 8B. Advertising opportunities may include, for example, 15-second attract loop spots with rich multimedia content provided by or created for the advertisers, banner ads, similar to advertising shown in FIG. 9, promotional opportunities, including context driven printing of coupons for advertisers from the Interactive Digital Wayfinding System, and the like. Users preferably have the option to use loyalty cards and other means of identification from different sources to avail themselves of special promotions and to request information from specific stores or advertisers.

Public Places & Venues:

This embodiment is similar to that described above with regard to shopping malls.

Sports Venues and Stadiums:

In the implementation of an Interactive Digital Wayfinding System for sports venues or stadiums, the user will be the visitors/attendees to the venue or stadium. The floor plan reflects the floor plan of the venue or stadium, and may be organized by zones or sections (groups of contiguous seats). The exhibitors are any advertisers approved by the facility's management for the venue or stadium. Advertising opportunities include, for example, 15-second attract loop spots, with rich multimedia content provided by or created for the advertisers, banner ads, similar to advertising shown in FIGS. 8A and 9, promotional opportunities, including context driven printing of coupons for advertisers from the Interactive Digital Wayfinding System, and the like. As with previously-described embodiments, users have the option to use loyalty cards from different sources to avail themselves of special promotions and to request information from specific advertisers. A section may also be devoted to special topicality relevant to the user, the exhibitor, the venue, or the like, such as sports trivia, relevant facts about the teams, and so forth.

Museums and Exhibit Halls:

This embodiment is similar to that described above with regard to sports venues and stadiums. The system of the present invention may provide previews of various pieces of art, along with narration. Virtual tours of remote artifacts and remote galleries may be provided, in addition to such functionality and features as are described herein with regard to other embodiments of the present system.

Convention Centers; Conference & Meeting Facilities:

This embodiment is similar to that described above with regard to tradeshows.

FIG. 11 represents an implementation of the interactive digital wayfinding system for special events, such as an association conference and meetings in a convention center or conference and meeting facilities. The layout of the facility, with one or more levels, is depicted with a 3D model. All schedules and events are tagged in the respective halls and/or rooms and other locations in the facility, with an attract loop preferably cycling through the conference agenda and an interactive mode to respond to a touch on a specific item on the display.

Hotels, Resorts & Banquet Facilities; Golf & Spa Resorts:

This embodiment is similar to that described above with regard to Convention Centers. Additionally, the range of services provided including spa, golf, and tours could all be represented in a context-sensitive manner in the data-driven interactive digital wayfinding system, with a 2D or a 3D representation of the hotel or resort facilities.

Inside Large Stores, Such as Big-Box Retail or Grocery, to Find Specific Aisle and Section for a Specific Product:

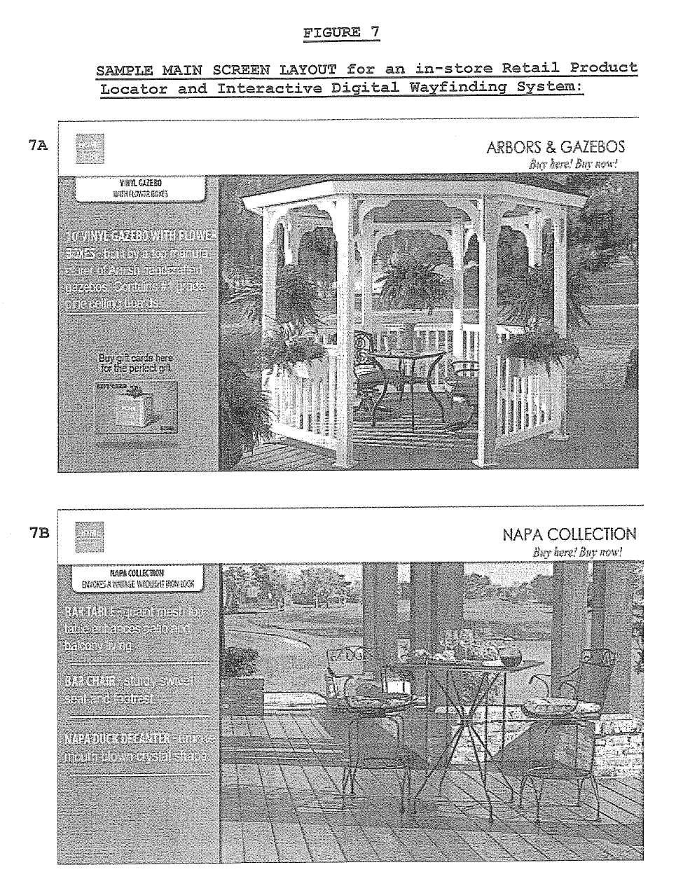

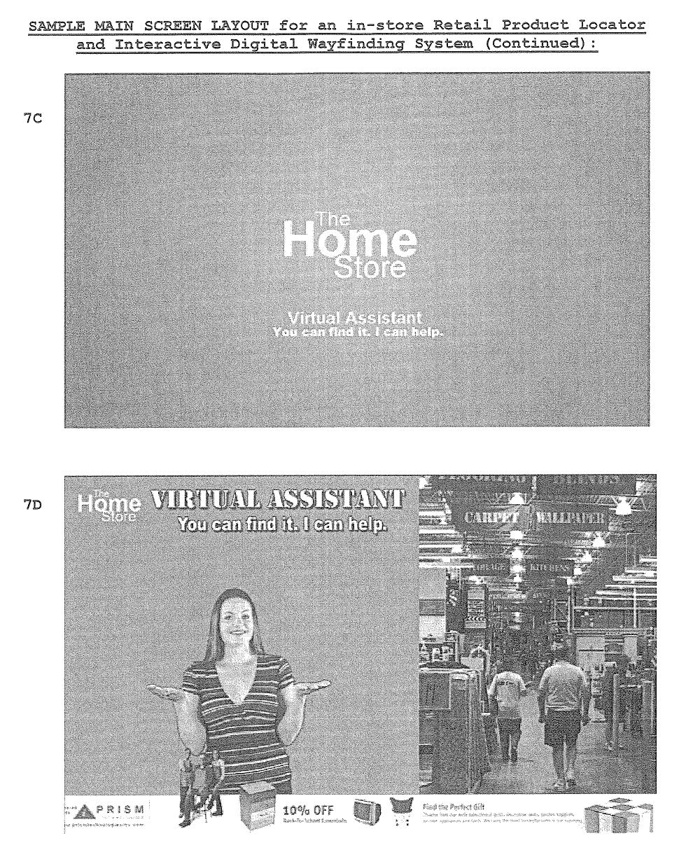

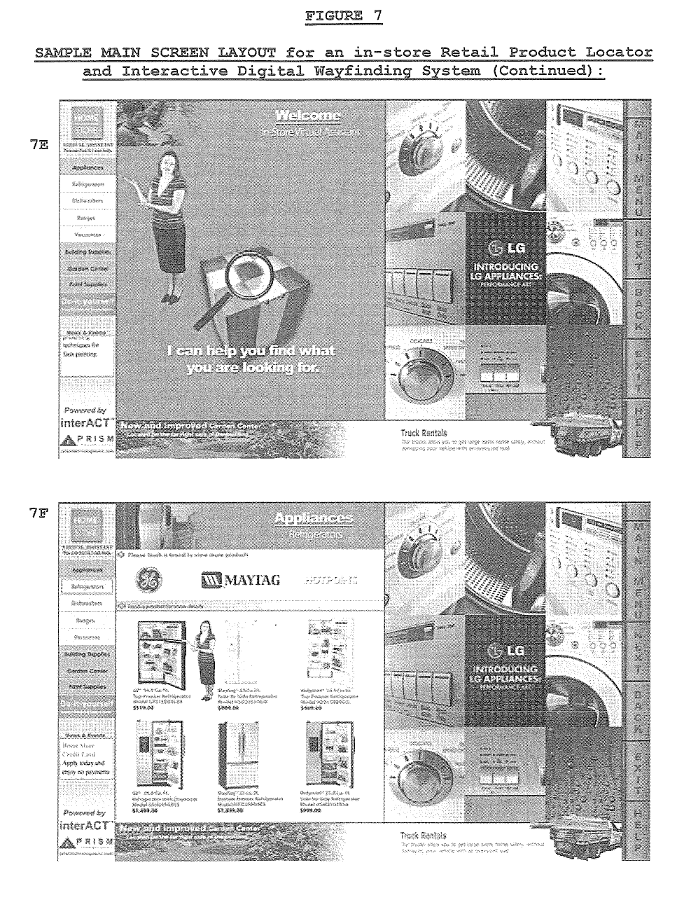

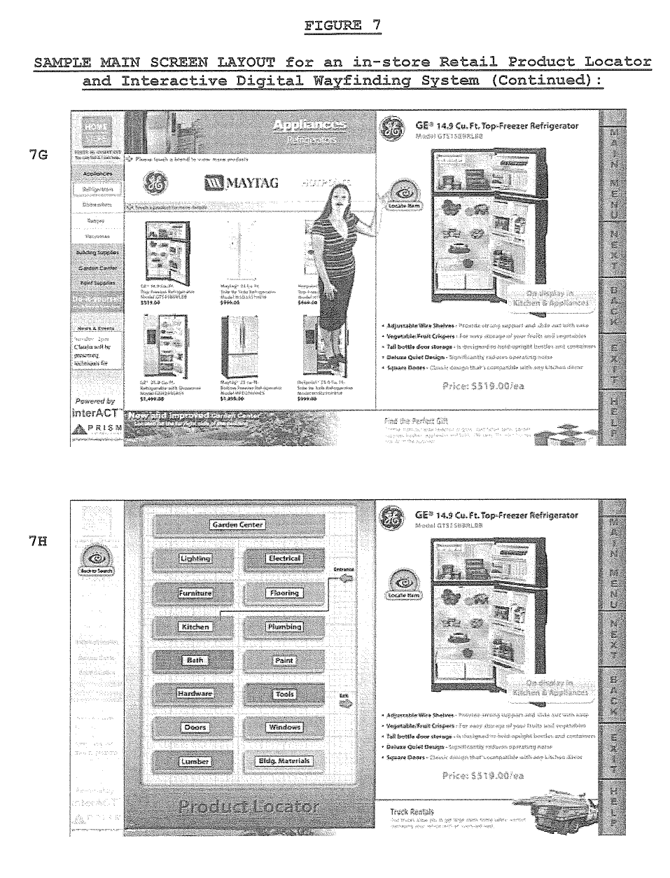

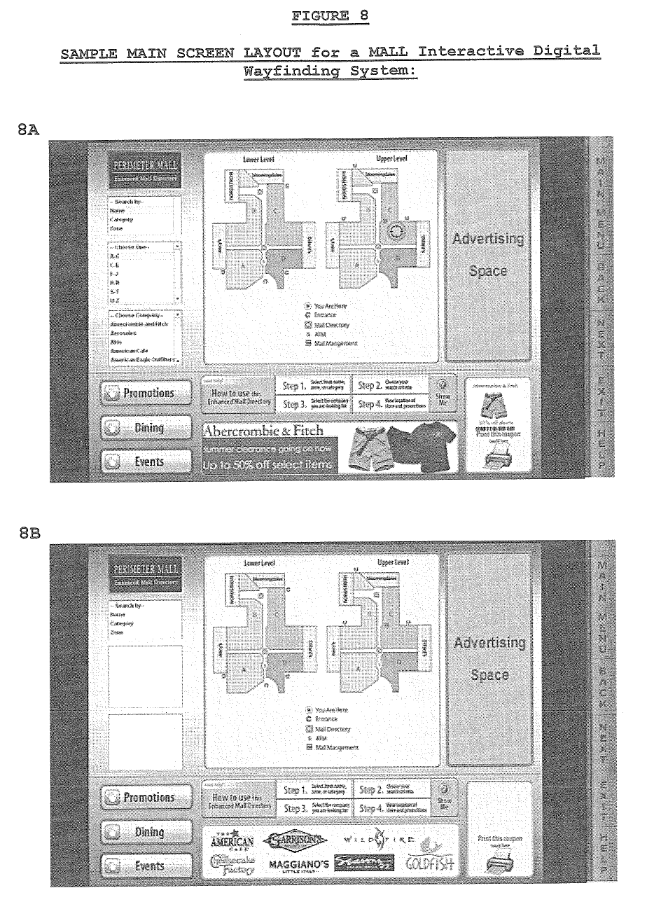

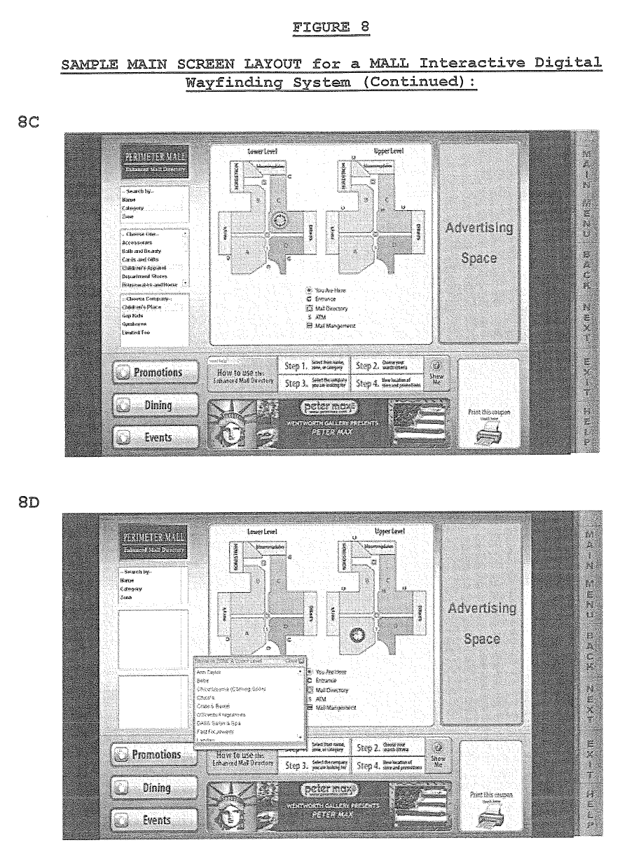

FIG. 7 is a series of snapshots illustrating a system configured to implement a preferred embodiment of the present invention for this application. These show the various functionalities of the interactive digital wayfinding system and associated services, such as the customer engagement process, virtual assistant interaction, product category, subcategory, family or item search engine, and corresponding wayfinding locator in the store for a store-front retail implementation.

In the implementation of an Interactive Digital Wayfinding System of the present invention for large stores, such as a big-box retail store, the user is the customer to the store. Customers approaching the system will prompt a virtual assistant, preferably comprising a video and/or animated image on the display to welcome and greet them, cooperatively coordinated with motion sensing devices, sensors, pressure pads, timed cycles and/or the like, which can be seen in FIG. 7C. The virtual assistant video and/or animated image, acts as a visual and audio helper to guide the customers to use the system in a context-driven method and as part of the customer engagement process. The search engine provided will answer two important in-store queries from customers: “do you have this item?” and “where can I find the item?” at a product category, subcategory, family or item level, and the corresponding wayfinding locator in the store, as seen with reference to FIGS. 7D, 7E. The floor plan reflects the floor plan of the store, as seen in FIG. 7F, and may be organized by aisles and/or category and sub-category sections (e.g., plumbing, electrical, small appliances, or the like), as seen in FIG. 7H. Context-driven promotions, messaging, suggestions, and advertisements preferably are supported. The promotions may be for any advertiser or manufacturer as approved by the management for the store. Advertising opportunities may include, for example, 15-second attract loop spots, as seen in FIGS. 7A and 7B, with rich multimedia provided by or created for the advertisers, banner ads, similar to advertising shown in FIGS. 9 and 7F, promotional opportunities, including context driven printing of coupons for advertisers from the interactive digital wayfinding and product locator system of the present invention. Users have the option to use loyalty cards from different sources, to avail themselves of special promotions and to request information for specific products. Users are also able to scan a barcode of a product and get more information on the product, along with the ability to locate the product using the wayfinding logic, as shown in FIGS. 7F and 7G. The main section of the display includes the ability to browse products based upon categories and sub-categories, and the ability to locate the product using the wayfinding logic, as shown in FIGS. 7F and 7G. Such product information may be obtained from enterprise systems, such as SAP, Oracle and other similar ERP systems, as illustrated in FIG. 1.

Parking Lots to Locate Vehicles:

In the implementation of the Interactive Digital Wayfinding System of the present invention for parking lot applications, the user is the customer or prospect to the venue or store. The floor plan reflects the floor plan of the parking lot. The exhibitors may be any advertisers approved by the facility's management for the venue or store. Advertising opportunities may include, for example, 15-second attract loop spots, with rich multimedia content provided by or created for the advertisers, banner ads, similar to advertising shown in FIG. 9, promotional opportunities, including context driven printing of coupons for advertisers from the Interactive is Digital Wayfinding System. Users have the option to use loyalty cards from different sources to avail themselves of special promotions and to request information from specific advertisers. A section of the display also is devoted to associated services, including quick check-in and check-out capabilities, key dispensers, and other relevant services.

Thus, it should be understood by those of ordinary skill in the art that the system, method, and apparatus for providing interactive digital wayfinding, and related services, may comprise various embodiments and/or combinations of embodiments. Further, those of ordinary skill in the art will recognize that alternate embodiments of the present invention may be enabled through the use of one or more of the herein-described alternatives, solely or in varying combination. Other embodiments may include equivalent technologies not now known but may be developed in the future that will replace or substitute the components as described herein.

Having, thus, described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is:

1. An interactive digital wayfinding system, comprising:
a. interactive display means for interfacing with a user of said system;
b. a computer readable program means for receiving data request input from the user, for processing said user input, for querying a data source relevant to said user input, for processing data retrieved from said data source, and for providing a response to the user according to the user's request;
c. means for outputting said response to the user;
d. said data request input from the user selected from the group consisting of at least the following:
i. a search request;
ii. a digital route trace request;
iii. a destination location indicator;
iv. an origin location indicator;
v. a request for display of enhanced directory information;
vi. a request for enhanced information by category or sub-category item listing exhibitor information regarding products, services, or news item;
vii. a request for information;
viii. a request for meeting;
ix. a request to participate in a survey;
x. a request for optimized digital route trace to multiple locations;
xi. a request for an enhanced list of exhibitors and exhibitor information;
xii. a request for schedule, workshop, meeting, session, or event information;
xiii. a request for schedule, coupon, vendor special, premium, or loyalty information;
xiv. a request for a dining location;
xv. a request for a local attraction; and,
xvi. a request for other pastime materials.

2. The system of claim 1, further comprising a user identification means.

3. The system of claim 2 wherein the user identification means is selected from the group consisting of a badge, a barcode reader, a smartcard reader, an RF identification reader, a proximity card identification reader, a biometric identification device, and a manual input device.

4. The system of claim 1, further comprising means for providing a report or logging means to a stakeholder of the system.

5. The system of claim 3 wherein said user identification means establishes a link between the user and the stakeholder for purposes of outputting a stakeholder response to the user according to the user's information or data request.

6. The system of claim 5, wherein said means for outputting said response to the user is selected from the group consisting of a printer, a facsimile transmission, an electronic transmission, an electronic transmission to a user device, and a display output.

7. The system of claim 1, further comprising means for delivering marketing, advertising, directory, and attract loop spots to a user thereof.

8. The system of claim 1 further comprising a visual map for a location perceivable by a user in two or more dimensions.

9. The system of claim 1 wherein said visual map includes a plurality of floor levels.

10. The system of claim 1 further comprising a virtual assistant inviting interaction from a user thereof.

11. The system of claim 10, wherein said virtual assistant offers to provide a visual guide to the user for subsequent operation of said system.

12. The system of claim 1 further comprising a search engine for processing a user search request, said search engine processing said user request by criteria selected from the group consisting of a company name, a location identifier, a booth identifier, a category, a subcategory, a product, a product feature, a product location, a service, and a service provider location.

13. The system of claim 1 further comprising means to display and output one or more visually-based marketing elements, said marketing elements selected from the group consisting of a multimedia presentation, company information, a context-driven promotion, a context-driven sales offering, a context-driven coupon, promotional or informational item, a detailed product listing, a detailed service listing, a request for information, a “what's new” listing, a conference-at-a-glance listing, a workshop, a workshop schedule, and a workshop session.

14. The system of claim 1 further comprising means to display and output one or more context-driven informational elements.

15. The system of claim 1 wherein said system responds to user input by associating a context-based rule to ascertain and query a data source, and thereafter to output context-specific content to the user.

16. The system of claim 1 wherein said system responds to user input by associating a marketing-based rule to ascertain and query a data source, and thereafter to output context-specific content to the user.

17. The system of claim 1, wherein said interactive display means is selected from the group consisting of a touch screen, an overlay, and an interactive projection system.

18. The system of claim 1, wherein said means for displaying said response to the user delivers its output in visual, rich multimedia format.

19. The system of claim 1, wherein said system is adapted to an exhibition venue and exhibition content.

20. The system of claim 1, wherein said system is adapted to a shopping mall venue and shopping mall content.

21. The system of claim 1, wherein said system is adapted to a sport venue and sport content.

22. The system of claim 1, wherein said system is adapted to a museum venue and museum content.

23. The system of claim 1, wherein said system is adapted to convention or conference center venue and convention or conference center content.

24. The system of claim 1, wherein said system is adapted to a retail or grocery venue and retail or grocery content.

25. The system of claim 24 further comprising (i) a user engagement process, (ii) virtual assistant interaction, (iii) a product category, subcategory, family or item search engine, and (iv) corresponding wayfinding locator.

26. The system of claim 1, wherein said system is adapted to a parking venue and parking venue content.

27. The system of claim 1, wherein said system is adapted to an industry selected from the group consisting of an entertainment complex, hotel or banquet facility, and resort, and associated content.

28. An interactive digital wayfinding system, comprising (a) a virtual assistant for interacting with a user of said system, (b) a multiple level and multiple dimension capable map display, (c) one or more of (i) a digital indication of an origin location and destination location and (ii) a digital route trace, (d) a search engine for searching by at least one of a company name, location identifier, product name, product identifier, and category, (e) means for delivering content to the user, said content selected from the group consisting of: a multimedia presentation, rich multimedia formatted content, an advertisement, content complying with the user's request for information, content complying with the user's request for a personal conference, content complying with the user's request for a further communication, a conference schedule, a workshop schedule, a product location, a product detail, a service location, a service detail, a request for a schedule, coupon, vendor special, promotion, premium, or loyalty-based deliverable, a visual representation of a product location upon said map, confirmation of a system-scheduled event, confirmation of a system-scheduled activity, context-driven informational elements, and context driven marketing elements.
